(19) United States
(12) Patent Application Publication
(10) Pub. No.: US 2005/0007681 A1
(43) Pub. Date: Jan. 13, 2005

(54) Optical system

(75) Inventors: Michio Shirai, Tokyo (JP); Kunihisa Obi, Tokyo (JP)

Correspondence Address: PILLSBURY WINTHROP, LLP, P.O. BOX 10500, MCLEAN, VA, 22102, US

(73) Assignee: Olympus Corporation, Tokyo (JP)

(21) Appl. No.: 10/850,439

(22) Filed: May 21, 2004

(30) Foreign Application Priority Data
May 23, 2003 (JP) 2003-145757
May 13, 2004 (JP) 2004-143703

(51) Int. Cl. G02B 3/02; G02B 13/18; G02B 17/00

(52) U.S. Cl. 359/708

(57) ABSTRACT

The invention provides an optical system comprising an optical element that is improved in terms of resistance to scratching, weather resistance, etc. and has an optical surface defined by an aspheric surface. The optical system comprises an optical element having an entrance surface and an exit surface. At least either one of the entrance surface and the exit surface is defined by an aspheric surface. The optical element comprises an organic/inorganic hybrid.

### BACKGROUND OF THE INVENTION

The present invention relates generally to an optical system comprising an optical element that has an optical surface configured as an aspheric surface other than a planar or spherical surface, and more particularly to an optical system comprising a plurality of optical elements, wherein an optical element having an optical surface configured as an aspheric surface is located at surfaces which receive light and light leaves.

Recently developed optical systems make much use of optical elements configured as aspheric surfaces other than planar or spherical surfaces for the purpose of achieving high precision and compactness. So far, optical surfaces of optical elements made of optical glass have been processed by polishing. However, polishing is unfit for mass production of optical elements, because it is very difficult to configure optical surfaces other than spherical or planar surfaces by means of polishing for which rotary polishing means are generally used. Thus, lenses or prisms having an aspheric surface as an optical surface are now fabricated by molding of optical resins or glasses using a molding tool or press mold having an aspheric surface shape.

Optical resins used to this end, for instance, include thermoplastic resins such as polymethyl methacrylates (PMMA), polycarbonates (PC), amorphous polyolefins (APO) and polystyrenes (PS), and thermosetting resins such as diethylene glycol bisallyl carbonate copolymers.

These optical resins have a coefficient of linear expansion of at least 10⁻5 that is larger than that of optical glass by an order of single or double digits and a relatively low glass transition point (Tg point), and their mechanical properties such as modulus of elasticity and thermal expansion coefficient change largely at around that temperature.

Thus, a cover glass is now located in front of the entrance surface of an optical element formed of optical resin and having a free form surface shape, thereby staving off damage to the resinous optical element (for instance, see JP(A)2003-84200).

For an optical element molded of optical glass, on the other hand, an aspheric lens is formed by press molding of optical glass at around 70° C. at which it softens.

### BRIEF DESCRIPTION OF THE DRAWINGS

FIGS. 1(A), 1(B) and 1(C) are illustrative of three embodiments of the organic/inorganic hybrid.

FIG. 2 is indicative of a transmittance vs. wavelength curve for the organic/inorganic hybrid optical material of Example 1.

FIG. 3 is indicative of the results of observation under a stereomicroscope of scattering of light in the organic/inorganic hybrid optical material of Example 1 upon irradiation with laser light.

FIG. 4 is illustrative of the free form surface prisms and optical paths through the prisms in Example 1.

FIGS. 5(A) and 5(B) are perspective view of the free form surface prisms in Example 3.

### SUMMARY OF THE INVENTION

The present invention provides an optical system, wherein an optical element comprising an organic/inorganic hybrid and having an aspheric optical surface is located on the entrance first surface or the exit first surface of an optical device.

According to the invention wherein the optical element comprising an organic/inorganic hybrid and having an aspheric optical surface is located on the entrance first surface or the exit first surface of the optical device, a cover glass indispensable for an optical element composed only of a synthetic resin can be dispensed with. In addition, the optical element of the invention is more unlikely to be affected by temperature and humidity and undergo dimensional changes than an optical element composed only of a synthetic resin, and so can have stabilized optical properties.

To add to this, the organic/inorganic hybrid can be easily prepared by molding as is the case with synthetic resins.

The optical element comprising the organic/inorganic hybrid of the invention is capable of shielding off ultraviolet radiation and moisture, and so staving off their adverse influences on other optical element(s) that forms an optical system.

The present invention also provides an optical system wherein the above aspheric optical surface is defined by an aspheric or free form surface other than a planar or spherical surface.

The optical element having an aspheric optical surface in the optical system of the invention can be fabricated by molding using the organic/inorganic hybrid; it is easy to fabricate an optical element having any desired surface shape such as a aspheric or free form surface shape other than a planar or spherical surface shape.

Further, the present invention provides an optical system wherein the above optical element has at a site other than the aspheric optical surface an engagement or alignment with a holder for the optical element.

An engagement or alignment with an optical element holder can be easily located at any desired site of the optical element of the invention other than the aspheric optical surface(s). With such an engagement or alignment such as a pit-and-projection engagement, the optical element can be easily mounted and fixed on the optical element holder. In addition, the optical element of the invention is less likely to change with temperature or humidity, so that the optical element can be positioned with increased precision.

The present invention provides a camera or projector comprising the above optical system.

### DESCRIPTION OF THE PREFERRED EMBODIMENTS

According to the invention, an optical element having at an entrance side first surface or an exit side first surface an aspheric optical surface other than a planar or spherical surface is molded or otherwise formed of a specific organic/inorganic hybrid. It is thus possible to achieve an optical system that makes it unnecessary to provide a cover glass or other protective member over an exposed surface of an optical element such as an entrance side first surface or an exit side first surface, which often comes in touch with the hand, etc. while the optical system is operated or during ordinary maintenance operation, and has improved optical properties as well.

It is noted that the “aspheric optical surface other than a planar or spherical surface” used herein means various optical surfaces represented by an aspheric optical surface and a free form surface.

It is also noted that the optical system wherein the optical element of the invention is used as a light entrance side first surface includes an imaging optical system such as a camera, and the optical system wherein the optical element of the invention is used as a light exit side first surface includes an optical system for liquid crystal projectors, wherein a light projection surface is exposed to view.

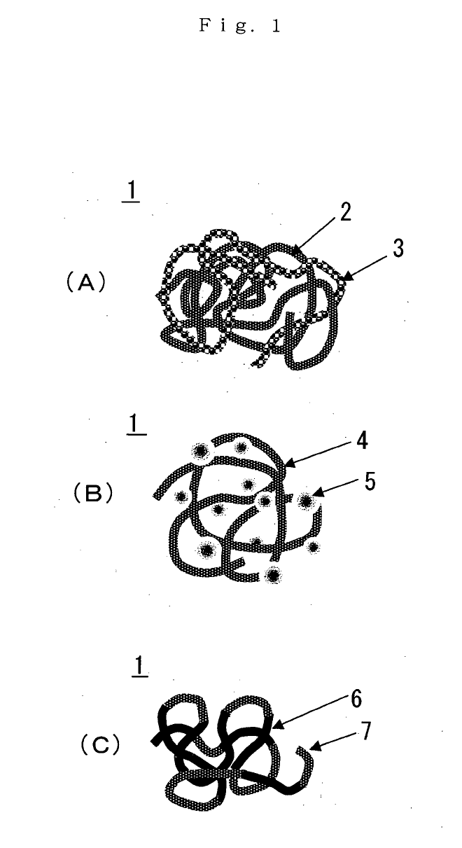

FIGS. 1(A), 1(B) and 1(C) are illustrative of specific organic/inorganic hybrids according to the invention.

An organic/inorganic hybrid 1 is broken down into three types, the IPN (interpenetrating polymer network) type wherein, as shown in FIG. 1(A), an organic skeleton polymer matrix 2 and an inorganic skeleton polymer matrix 3 are entangled and mutually interpenetrated, the composite structure type wherein, as shown in FIG. 1(B), an inorganic component 5 such as inorganic fine particles on a nano-scale level are dispersed in an organic polymer component 4, and the copolymer structure type wherein, as shown in FIG. 1(C), a monomer or oligomer 6 that is an organic component is copolymerized with a monomer or oligomer 7 that is inorganic component.

Also, a hybrid structure comprising two or more such types may be used. It is understood that between the organic component and the inorganic component there are interactions, for instance, intermolecular forces such as hydrogen bonding, dispersion force and Coulomb, and attraction due to covalent bonding, ionic bonding and π electron cloud.

As the organic component for the IPN type organic/inorganic hybrid, a chainlike or crosslinked polymer substance having an organic skeleton that mainly comprises a carbon-carbon bond in its main chain is used. That organic component, for instance, includes methyl methacrylate resin, polyolefin resin, polystyrene resin, norbornene resin, polycarbonate resin, ABS resin, polyamide resin, polyester resin, vinyl chloride resin and thermoplastic resins comprising copolymers of these resins as well as epoxy resin, unsaturated ester resin, acrylate resin, urethane resin, polyimide resin, phenol resin, fluororesin, allylate resin, ether resin, silicone resin and thermosetting resins such as resins obtained by modifying a part of these functional groups. In consideration of temperature stability and humidity stability, polyolefin-based resins are preferred.

The inorganic component, for instance, includes an inorganic polymer having a metalloxane skeleton, which is obtained by the sol-gel reaction of an organometallic compound selected from metal alkoxides, metal acetyl-acetonates and metal carboxylates containing an element such as Si, Ti, Zr, Al, Ba, Ta, Ge, Ga, Cu, Sc, Bi and lanthanide, and an inorganic polymer having in its skeleton a metal element such as Zn, Sn, In, Ge, and Pb. These inorganic polymers may additionally have sulfur, boron, selenium, tellurium or the like in their molecular chains.

Referring to how to synthesize the inorganic/organic hybrid having the IPN structure, the monomer or oligomer of the thermosetting resin that is the organic component is mixed with a metal alkoxide that is the inorganic component, if necessary, along with a solvent, a catalyst and a setting agent, so that the polymerization reaction of the resin monomer and the sol-gel reaction of the metal alkoxide are allowed to proceed at the same time, thereby producing a set organic/inorganic hybrid having a network structure wherein the organic and inorganic components are mutually entangled.

With this method, control of reaction rate may be gained depending on the type and amount of the solvent and catalyst used, and post-synthesis molding, coating and other processes may be regulated in dependence on the type and amount of the solvent used. Depending on the type and amount of the setting agent used, setting processes and conditions may also be controlled.

As the organic polymer component for the organic/inorganic hybrid of the composite structure type, use is made of the thermoplastic resins and thermosetting resins mentioned in conjunction with the IPN type organic/inorganic hybrid. The inorganic component, for instance, includes metal oxides, metal sulfides, metal nitrides, metal carbides, metal halides or pure metals, which are in a finely divided form having an average particle diameter of 200 nm or less, preferably about 1 to 50 nm, and more preferably about 1 to 10 nm, much smaller than the wavelength of light.

By way of example but not by way of limitation, the metal element contained in the inorganic component includes Si, Ti, Zr, Al, Ba, Ta, Ge, lanthanide, Zn, Sn, In, Y, Ni, Co, Cr, Au, Ag, Cu, Ca, Mg, Sc, and W. More specifically, SiO₂, TiO₂, ZrO₂, Al₂O₃, ZnS, BaTiO₃, MgF₂, In₂O₃, SnO₂, SiC and c-BN are usable. Compounds of nearly molecular size, for instance, silsesquioxanes having a ladder or cage structure may also be used.

For instance, the organic/inorganic hybrid having a composite structure may be synthesized by dispersing fine particles of the metal component uniformly in the organic component while the fine particles are kept much smaller than the wavelength of light.

More specifically, reliance may be on a kneading process, a process wherein sol-gel reactions are caused in the organic solvent for the formation of fine particles, a process wherein the organic resin monomer and metal complex are mixed together, and the metal component is thereafter reduced to simultaneously effect the formation of fine metal particles and the polymerization of the organic component, and a process wherein the surfaces of fine particles are previously treated for enhanced affinity for the organic component, so that the fine particles are easily dispersible.

For the organic component of the organic/inorganic hybrid of the copolymerization structure type, use may be made of various organic components such as thermoplastic resins and thermosetting resins mentioned in conjunction with the IPN structure, for instance, acrylate monomers and epoxy oligomers, and for the inorganic component, use may be made of inorganic component-containing organic monomers and oligomers that contain elements such as Si, Ti, Al, Ge, Se and Te. The copolymerization structure type organic/inorganic hybrid may be obtained by the copolymerization by mixing of the organic component and the inorganic component-containing organic monomer or oligomer, if necessary, along with a solvent, a catalyst and a setting agent.

As a result of the fact that the organic component is reinforced by the action of the inorganic component, the thus obtained organic/inorganic hybrid shows improvements in mechanical properties such as modulus of elasticity and surface hardness and improvements in thermal properties such as increases in thermal softening point and glass transition points and a lowering of thermal expansion coefficient. Such improvements in the properties of the organic/inorganic hybrid could be achieved due to the interactions on a molecular level or nano-scale of the organic and inorganic components, whereby any molecular vibration of the main chain skeleton of the organic component is held back. The organic/inorganic hybrid also shows a drop of water absorption and improvements in solvent resistance and weather resistance, because of having a closely packed structure.

In the organic/inorganic hybrid of the invention, the organic and inorganic components are mixed together on a molecular level or in a scale area smaller than the wavelength of light, so that the organic/inorganic hybrid is little affected by scattering of light, providing a transparent material.

Some organic/inorganic hybrids wherein the thermoplastic resin is used as the organic component may be configured as by injection molding into any desired free forms, while some wherein the thermosetting resin is used as the organic component may be used in a liquid form after thermosetting, so that they can be cast into a mold for any desired free forms. Because of having such formability, the organic/inorganic hybrid of the invention may be formed into an optical element having an aspheric or free form surface other than a planar or spherical surface by the application of synthetic resin-molding techniques.

An optical element fabricated using the organic/inorganic hybrid obtained as mentioned above has a surface hardness so high that even when it is located on the surface of an optical system while exposed to open view, its surface is hardly scratched or damaged by manual handling or the like. The organic/inorganic hybrid used herein should preferably have a surface hardness of at least 6H in terms of pencil hardness.

The organic/inorganic hybrid of the invention is also smaller than conventional resins in terms of the rate of change in the coefficient of thermal expansion and refractive index due to temperature changes, so that there can be achieved a high-precision optical system that has stabilized optical properties with respect to environmental temperature changes.

Further, when an antireflection film is formed on the surface of an optical element comprising the organic/inorganic hybrid by means of vacuum film formation, that surface on which the antireflection film is to be formed is brought up to higher temperature as compared with optical resins, so that the adhesion of the antireflection film can be enhanced. In addition, an optical element (substrate) comprising the organic/inorganic hybrid is less deformable, and so the antireflection film hardly comes off.

The present invention is now explained specifically with reference to examples and comparative examples.

### EXAMPLE 1

Thirty-seven (37) parts by weight of methanol-dispersed silica sol (Organosilica Sol MA-ST-S made by Nissan Chemical Co., Ltd. with a number base mean particle diameter of 10 nm, a particle size distribution of 1 to 100 nm and a fine silica particle content of 25% by mass) were added to and mixed with 30 parts by weight of iso-propanol, and the solution was stirred with the addition thereto of 3.82 parts by weight of γ-methacryloxypropyl-trimethoxysilane and 3.05 parts by weight of phenytri-methoxysilane.

While the resulting solution was stirred, 0.14 part by weight of stannous octylate (KCS-405T made by Johoku Chemical Co., Ltd.) was added dropwise thereto, followed by a 72-hour stirring at 25° C. Thereafter, 7.11 parts by weight of neopentyl glycol diacrylate (NP-A made by Kyoeisha Chemical Co., Ltd.), 2.14 parts by weight of trimethylolpropane triacrylate (TMP-A made by Kyoeisha Chemical Co., Ltd.) and 0.20 part by weight of a polymerization initiator (Irgacure 500 made by Chiba Specialty Chemicals Co., Ltd.) were added under agitation to the resultant solution while a filter paper having a pore diameter of 3 μm was used for removal of suspending dust, etc. Using a reduced-pressure evaporator, volatile solvents such as methanol and isopropanol were distilled out of the solution, thereby obtaining a free-flowing organic/inorganic hybrid composition.

### Preparation of Sample for Measuremnet of Optical Properties

The obtained composition was poured to a depth of 10 mm in a cylindrical vessel of 20 mm in diameter and 20 mm in depth, and irradiated with ultraviolet radiation having a light intensity of 17 W/m² at a light wavelength of 365 nm for 24 hours in a nitrogen atmosphere to obtain an organic/inorganic hybrid having a diameter of 20 mm and a thickness of 10 mm, out of which a sample was cut. This sample was found by measurement to have a coefficient of linear expansion β of 4.9×10⁻⁵/K.

By measurement, that sample was found to have a rate of refractive index change of 90×10⁻⁶/K, a 30% reduction with respect to 130×10⁻⁶/K that is the rate of refractive index change of a general optical acrylic resin with temperature.

Using a dynamic viscoelasticity measuring device (Q-800 made by TAI), the dynamic viscoelasticity of a sample of 5 mm in width, 25 mm in length and 1 mm in thickness was measured under conditions of three-point bending, a heating rate of 2° C./min and a frequency of 10 Hz. Consequently, it was found that up to 200° C., there was no significant drop of storage elastic modulus, indicating that the sample did not soften even at high temperature. By measurement, the obtained organic/inorganic hybrid was also found to have a pencil hardness of 9H or greater.

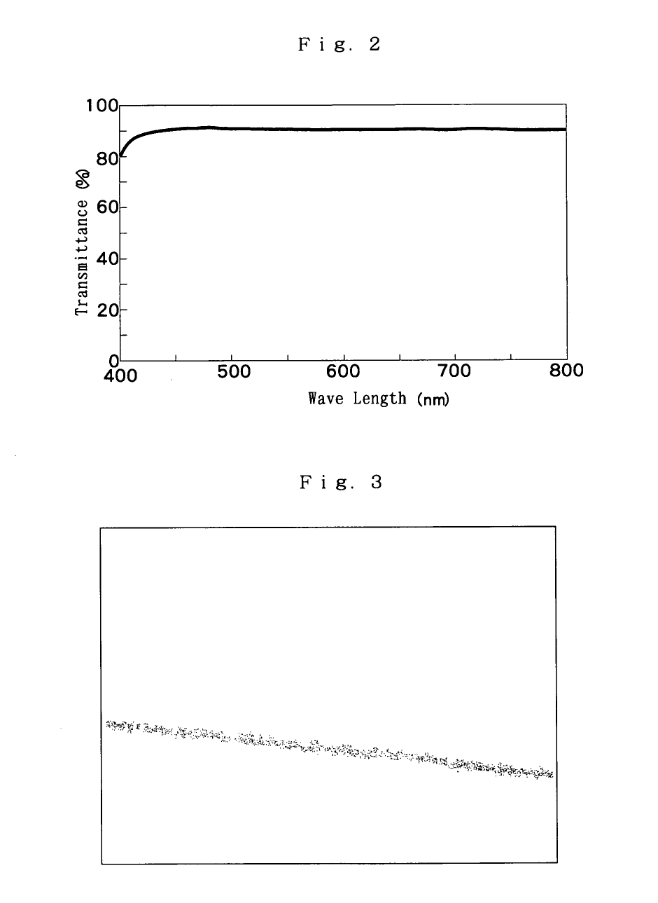

The organic/inorganic hybrid was visually transparent. As a result of measurement of the thickness direction light transmittance of a sample of 20 mm in diameter and 3 mm in thickness, it was found that the sample had a light transmittance enough for an optical element at wavelengths of 400 nm to 800 nm, as can be seen from FIG. 2. As a result of 20× observation under a stereomicroscope (SZX12 made by Olympus Optical Co., Ltd.) of laser light loci upon irradiation with a He—Ne laser of 633 nm wavelength, the laser light loci were little observed as can be seen from FIG. 3, indicating that there was little or no scattering of light.

### Preparation of Free Form Surface Prism

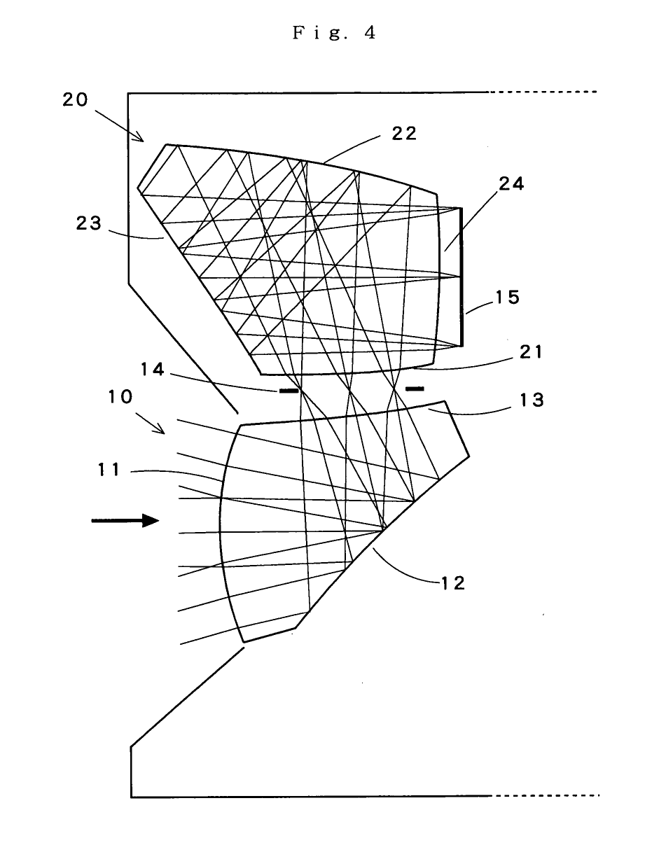

The organic/inorganic hybrid composition was cast into a mold to prepare a free form surface prism having optical paths as shown in FIG. 4. The size of an entrance surface 11 was 10 mm×10 mm.

More specifically, there was provided a mold the top and bottom sides of which had no optical action. Through an inlet in the top side of the mold, the previously prepared organic/inorganic hybrid composition was poured in the mold. The top side of the mold was formed of reinforced glass transparent to ultraviolet radiation. The organic/inorganic hybrid composition was irradiated, from above, with ultraviolet radiation having a light intensity of 150 W/m² at 365 nm wavelength for 300 seconds. Then, a prism comprising the set organic/inorganic hybrid was released out of the mold.

It was found that the surfaces and configuration of the mold were precisely transferred onto the prism; moldability was good enough.

In an optical system made up of prisms obtained in this way, light rays leaving an object transmitted through an entrance surface 11 of a first prism 10, and were internally reflected at a reflecting surface 12, leaving an exit surface 13. Then, the light rays transmitted through an entrance surface 21 of a second prism 20 via a stop 14, and were internally reflected at a second reflecting surface 23, leaving an exit surface 24 to form an image on an image plane 15. It is here noted that the 1^{st} to 3^{rd} surfaces 11 to 13 of the first prism were each defined by a free form surface, and that the entrance surface 11 of the first prism 1 was exposed to the surface of an optical device.

The entrance surface 11 of the formed first prism had a pencil hardness of 9H. The resistance to scratching of the surface of the prism was estimated in an approximately actual mode as follows. A prism sample was strongly rubbed ten times in opposite directions, using steel wool (#0000 made by Nippon Steel Wool Co., Ltd.). As a result of visual observation of the sample, there was no scratch, indicating that the sample had enough resistance to scratching.

### COMPARATIVE EXAMPLE 1

A composition was obtained by stirring together 7.11 parts by weight of neopentyl glycol diacrylate (NP-A made by Kyoeisha Chemical Co., Ltd.), 2.14 parts by weight of trimethylolpropane triacrylate (TMP-A made by Kyoeisha Chemical Co., Ltd.) and 0.20 part by weight of a polymerization initiator (Irgacure 500 made by Chiba Specialty Chemicals Co., Ltd.). This composition was poured to a depth of 10 mm in a cylindrical vessel of 20 mm in diameter and 20 mm in depth, and then irradiated with ultraviolet radiation having a light intensity of 1.7 W/m² at a light wavelength of 365 nm for 24 hours in a nitrogen atmosphere, thereby obtaining an optical resin of 20 mm in diameter and 10 mm in thickness. A sample was cut out of the optical resin, and measured for the coefficient of linear expansion β, which was 7.5×10⁻⁵/K, 1.53 times larger than that of the organic/inorganic hybrid material according to Example 1.

### EXAMPLE 2

A solution composed of 6.6 grams of methyltrimethoxysilane as the organosilicon compound that was the inorganic component, 1.6 grams of phenyltrimethoxysilane as a phenyl-group containing organosilicon compound, 6.0 grams of 3-methacryloxypropyltrimethoxysilane as a polymerization group-containing organosilicon compound and 4.4 grams of water was stirred at 25° C. for 48 hours, thereby subjecting the inorganic component to a sol-gel reaction. Then, by-products, say, water and methanol were removed to obtain an inorganic component reaction solution.

Ten (10.0) grams of methyl (meth)acrylate that was the organic component and 0.1 gram of an ultraviolet setting agent (Irgacure 500 made by Nagase Industries, Ltd.) were added to the obtained inorganic component reaction solution, thereby obtaining an organic/inorganic hybrid material solution.

Then, this organic/inorganic hybrid composition was used to prepare a prism having free form surfaces as in Example 1. The surfaces and configuration of the mold were precisely transferred onto the obtained prism; moldability was good enough. The entrance surface of the formed prism was strongly rubbed ten times in opposite directions, using steel wool (#1000 made by Nippon Steel Wool Co., Ltd.). As a consequent of visual observation of the prism, there was no scratch; the prism was of enough resistance to scratching. The organic/inorganic hybrid had a pencil hardness of 8H.

### EXAMPLE 3

Nine (9) parts by weight of bisphenol A type epoxy resin represented by the following formula 1 (with a weight-average molecular weight of 380) and 13.67 parts by weight of 3-glycidoxypropyltrimethoxysilane were mixed together. Then, the mixture was stirred at 0° C. with the addition thereto of 2.84 parts by weight of tetraethylenepentamine, and 1.56 parts by weight of pure water added to the mixture, followed by a further one-hour stirring, thereby obtaining a transparent, homogeneous organic/inorganic hybrid composition.

After defoamed in vacuo, the organic/inorganic hybrid composition was poured in a mold having a pit in a side, where it was let stand at 25° C.±5° C. for 24 hours. Then, a first prism having a projection on a side, as removed out of the mold, was heated at 80° C. for 2 hours.

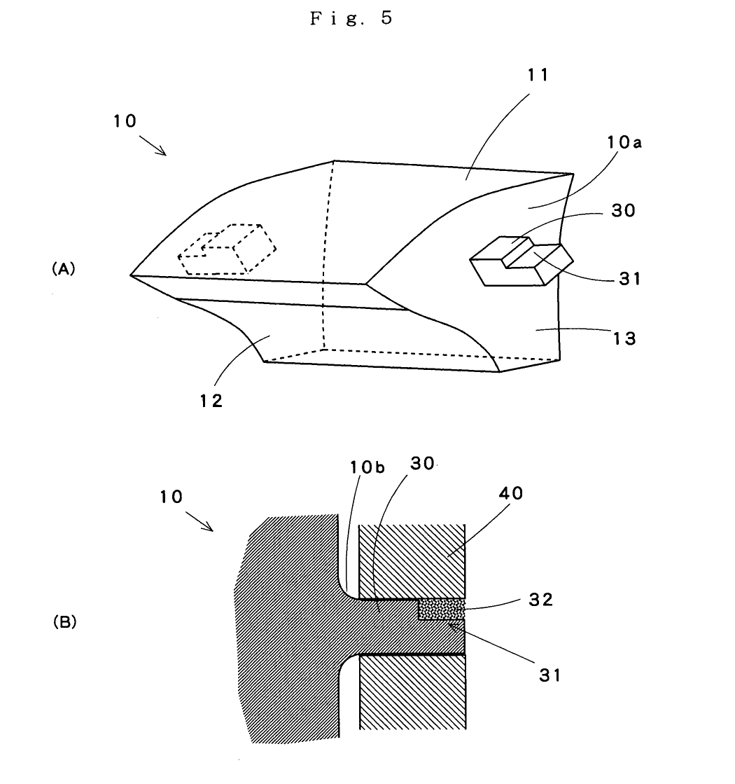

In this way, a first prism 10 made up of the organic/inorganic hybrid and having a projection 30 on the side was obtained, as shown in FIG. 5(A).

The surfaces and configuration of the mold were precisely transferred onto this prism; moldability was good enough. As shown in the partial section of FIG. 5(B), a gap is provided between a side surface 10a of a prism 10 and an engagement 40 of an optical device while a side surface of a projection 30 provides an abutting surface against the engagement 40 of the optical device, so that a connector 10b having a spreading-out curved surface, a slant or the like on a side surface 10a can be formed at a surface where the side surface of the prism comes on the projection, making distortion unlikely to occur during molding.

Accordingly, strain occurring upon the prism fixed to the holder does not affect the prism, so that a precisely aligned optical system can be obtained. If a pit 31 is formed in the alignment projection 30, it is then possible to ensure an adhesive-receiving port 32, so that just only precise alignment but also reliable bonding can be ensured. As in the previous examples, this prism has a sufficient surface hardness. The organic/inorganic hybrid had a pencil hardness of 6H. 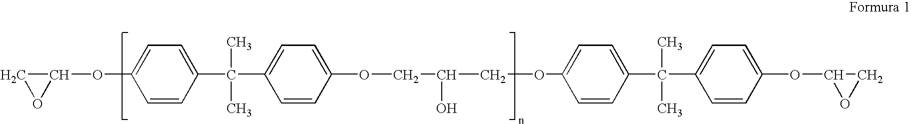
Here n is 0 or an integer of 1 or greater, and the average molecular weight is 380.

According to the optical system of the invention as described above, the surface of the optical element exposed on the surface of the optical device has enough resistance to scratching, so that the optical surface is unlikely to be scratched or otherwise damaged during ordinary operation even without recourse to a cover glass or other surface protecting member, and the optical performance of the optical element can be kept intact. Further, it is not only possible to fabricate an optical element having satisfactory optical properties and a high degree of freedom in configuration design as well as various surfaces such as an aspheric or free form surface, but it is also possible to provide an optical system that can be easily set up, using an engagement or alignment site for fixing an optical element in place.

1. An optical system comprising an optical element having an entrance surface and an exit surface, wherein at least either one of said entrance surface and said exit surface is defined by an aspheric surface, and said optical element comprises an organic/inorganic hybrid.

2. The optical system according to claim 1, wherein said aspheric surface is defined by an aspheric or free form surface other than a planar or spherical surface.

3. The optical system according to claim 1, wherein said optical element has at a site other than the aspheric optical surface an engagement or alignment with a holder for said optical element.

4. A camera comprising an optical element having an entrance surface and an exit surface, wherein at least either one of said entrance surface and said exit surface is defined by an aspheric surface, and said optical element comprises an optical system comprising an organic/inorganic hybrid.

5. A projector comprising an optical element having an entrance surface and an exit surface, wherein at least either one of said entrance surface and said exit surface is defined by an aspheric surface, and said optical element comprises an optical system comprising an organic/inorganic hybrid.
